(19) United States
(12) Patent Application Publication
(10) Pub. No.: US 2012/0144729 A1
(43) Pub. Date: Jun. 14, 2012

(54) INSECT BAIT STATION

(76) Inventors: Frederique M. de Lame, Scottsdale, AZ (US); Arlana M. Brugato, Scottsdale, AZ (US); Christopher J. Wolpert, Scottsdale, AZ (US); Cedric J. McCants, Phoenix, AZ (US)

(21) Appl. No.: 12/964,395

(22) Filed: Dec. 9, 2010

(51) Int. Cl. A01M 1/20; B23P 11/00

(52) U.S. Cl. 43/131; 29/428

(57) ABSTRACT

Flexible insect bait stations and methods for manufacturing the same are provided. In accordance with an exemplary embodiment, an insect bait station is in the form of an elongated strip comprising a container defining a chamber for holding insect bait, the container comprising a base having a bottom wall, and peripheral side walls, wherein the base is constructed of a flexible material providing for mounting the bait station on irregular surfaces.

### BACKGROUND OF THE INVENTION

1. Field of the Invention

The present invention generally relates to insect bait stations, and more particularly relates to flexible insect bait stations.

2. Description of the Prior Art

The control of insects has been attempted by many methods. Delivering an insecticide in a bait form to attract insects is one well established means of such control. While it is possible to simply distribute loose bait directly to an insect infested area, a more controlled delivery means involves the use of bait containing structure, or station that provides a means for allowing entry and exit of insects into and out of a bait chamber. By providing bait in a structure, one gains more control over, amongst other things, where the bait actually resides, what can access the bait, and permits easy removal of the insecticide from the area if so desired.

Traditional insect bait stations such as those described in U.S. Pat. No. 4,837,969 provide devices generally comprising a well area for securing a bait, a means for providing access for insects and relatively complex, such as the multilobed structure described therein, means for covering the bait. The size and configuration of such structure often places limitations on how and where the stations can be deployed.

Accordingly, it is desirable to provide insect bait stations that deliver increased flexibility in how and where consumers can employ them to control insects. In addition, it is desirable to provide methods for manufacturing such bait station products. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Flexible insect bait stations and methods for manufacturing the same are provided. In accordance with an exemplary embodiment, an insect bait station is in the form of an elongated strip comprising a container defining a chamber for holding insect bait, the container comprising a base having a bottom wall, and peripheral side walls, wherein the base is constructed of a flexible material providing for mounting the bait station on irregular surfaces.

In accordance with another exemplary embodiment, an insect bait station is in the form of an elongated strip comprising a base having a plurality of containers aligned in row, each of the containers having a bottom wall and peripheral side walls defining a chamber holding a bait, wherein at least the bottom wall is constructed of a flexible material providing for mounting the bait station on irregular surfaces.

### BRIEF DESCRIPTION OF THE DRAWINGS

The present invention will hereinafter be described in conjunction with the following drawing figures, wherein like numerals denote like elements, and wherein:

FIG. 1 is a perspective view of a bait station according to the present invention.

FIG. 2 is a perspective view of an embodiment of the bait station shown in FIG. 1 having end-tab segments.

FIG. 3 is a perspective view of a multiple well embodiment of the bait station according to the present invention.

FIG. 4 is a cross section through the well of the bait station shown in FIG. 1.

FIG. 5 is a cross section through a well of a filled and sealed bait station according to the present invention.

FIG. 6 is an exploded view of the components of a filled bait station according to the present invention.

FIG. 7 is a perspective view of a filled bait station according to the present invention with the top and bottom protective layer partially peeled back

FIG. 8 is a perspective view of another embodiment of a bait station according to the present invention.

FIG. 9 is a perspective view of another embodiment of a bait station shown in FIG. 8 having end tabs.

FIG. 10 is a perspective view of another embodiment of a bait station according to the present invention.

FIG. 11 is a cross section through a well of a filled bait station as shown in FIG. 10.

FIG. 12 is a perspective view of series of attached sealed bait stations according to the present invention.

FIG. 13 is a perspective view of another embodiment of a series of attached bait stations according to the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The present invention is now described with reference to the drawings, wherein like reference numerals are used to refer to like elements throughout. In the following description, for purposes of explanation, numerous specific details are set forth in order to provide a thorough understanding of the present invention. It will be evident, however, to one skilled in the art that the present invention may be practiced without these specific details.

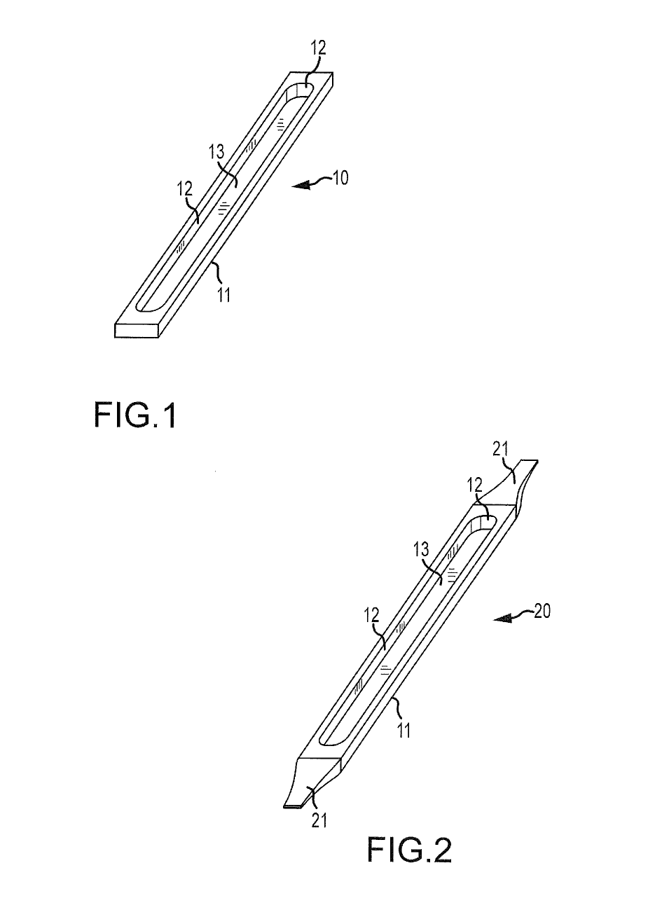

Referring now to FIG. 1, an exemplary embodiment of a bait station according to the present invention is shown and referred to generally at numeral 10. In this embodiment, bait station 10 in the form of an elongated strip comprising a container defining a chamber for holding insect bait, the container comprising a base 11 having a bottom wall 13, and peripheral side walls 12, wherein the base is constructed of a flexible material providing for mounting the bait station on irregular surfaces.

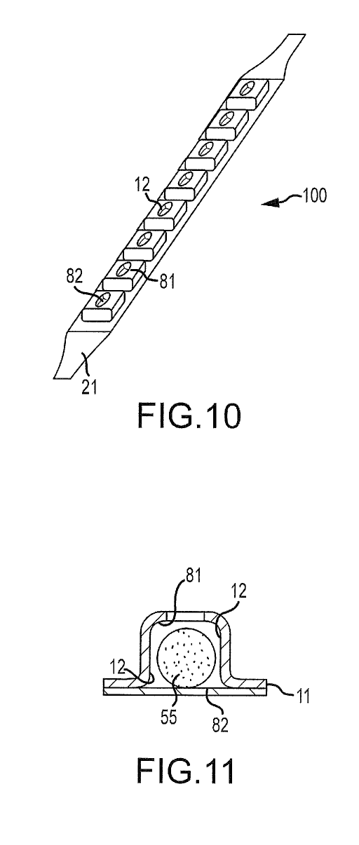

As shown in FIG. 2, the bait station 20 may be further refined wherein the base 11 is disposed between end tab segments 21. These end tab segments may perform numerous functions. For example, they may provide the user with a gripping means to facilitate placement and removal of the bait station. They may also provide an additional route for insects to climb upon the station in order to access the bait. Examples of such end tab segments range from the form of a three dimensional ramp structure end tab segment 21 as shown in FIG. 2, to a more basic flat end tab segment 21 as shown in FIG. 9 and FIG. 10.

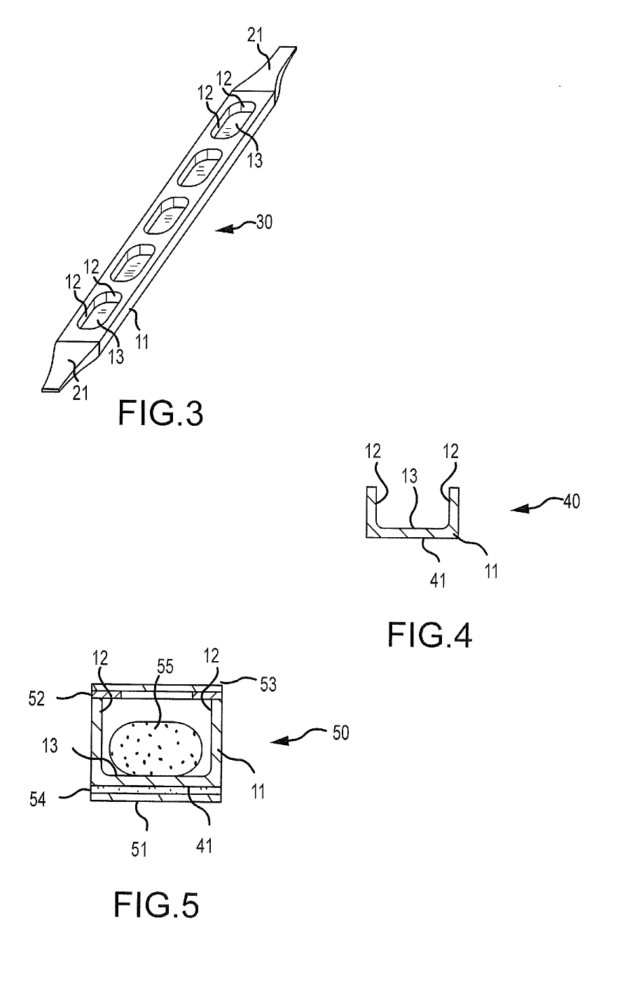

In an alternative embodiment as shown in FIG. 3, the bait station 30 may comprise a base having a plurality of chambers having bottom walls 13, and peripheral side walls 12.

In FIG. 4, a cross section 40 of an empty bait station sectioned through a chamber according to the present invention is shown. Base 11 comprises a container defining a chamber having peripheral side walls 12, a bottom wall 13. The base 11 has a bottom surface 41 that contacts a mounting surface when the bait station is used.

Referring to FIG. 5, a cross section 50 of a filled bait station sectioned through a chamber according to the present invention is shown. Base 11 comprises a container defining a chamber having peripheral side walls 12, a bottom wall 13. Top wall 52 may be a separate structural member attached to a base 11 or may be integrally formed into the base itself during molding. The top wall 11 may serve as a means to regulate insect access to the bait 55 by featuring one or more openings of sizes adapted to the type of insect, or insects, targeted by the station. These openings allow the entry and exit of insects into and from said chamber. Removable top cover 53 provides a means to seal the bait station to prevent drying or spillage of the bait 55 during transport and storage prior to consumer use of the bait station. Adhesive layer 54 is applied to the bottom surface 41 providing a means to secure the bait station 50 wherever the user wishes to place the station to combat insects. The adhesive layer 54 permits installation of the bait station 50 in orientations that traditional bait stations may not achieve. The bait station may be placed on surfaces at extreme angles, perpendicular to the ground, or even upside down. A removable bottom protective layer 51 covers the exposed bottom surface of the adhesive layer 54 and is designed to be removed prior to application of the bait station to a mounting surface.

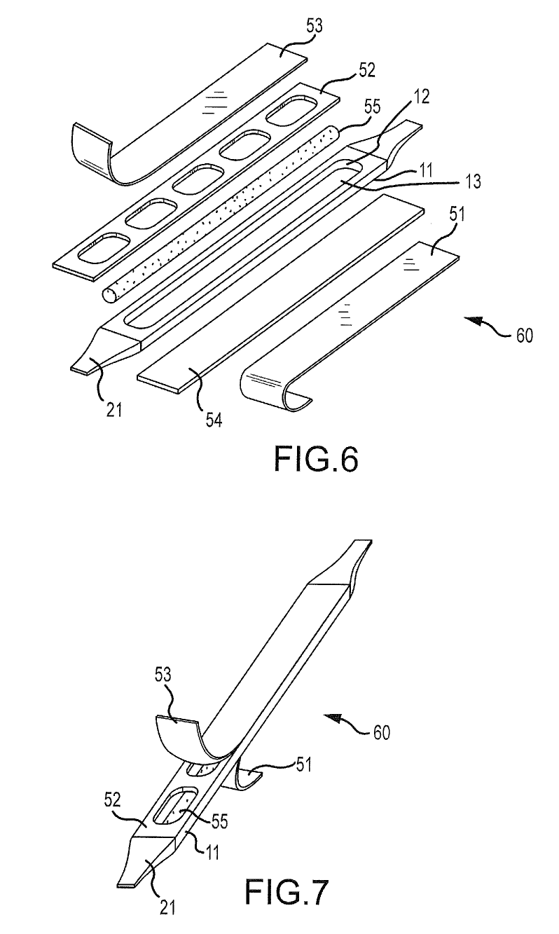

FIG. 6, an exploded view of an exemplary bait station 60, and FIG. 7, the exemplary bait station 60 assembled and partially opened, detail the distinct parts of one possible embodiment. The bait station 60 comprises: base 11 disposed between end tab segments 21; peripheral side walls 12 and bottom wall 13 define a chamber for holding insect bait 55; top wall structure 52 having a plurality of openings for allowing entry and exit of insects from the chamber; removable top cover 53 provides a means to seal the chamber from environmental exposure and leakage; adhesive layer 54 and protective layer 51 provide a means for securing the station to a mounting surface. FIG. 7 further illustrates the removable top cover 53 and removable protective layer 51 partially peeled away from the bait station 60.

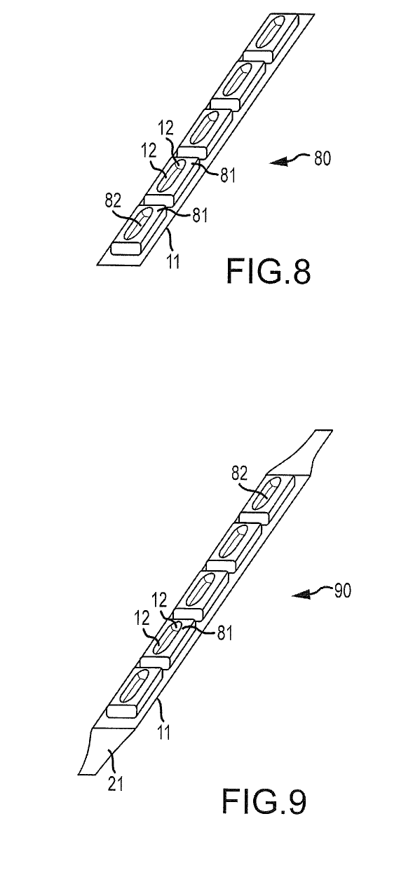

An alternate exemplary bait station 80 in the form of an elongated strip comprising a base 11 having a plurality of containers aligned in a row is shown in FIG. 8. Each container comprises peripheral side walls 12, and bottom wall 82 that define a chamber for holding insect bait. As also shown in FIG. 11, the chamber may be further defined by top wall 81 that may be formed as part of a single base structure 11, or as a separate structure member 52 as shown in FIG. 6. A further embodiment of the bait station 90 is shown in FIG. 9, further refined wherein the base 11 is disposed between end tab segments 21. The containers present on the bait station may take any form moldable on base 11 such as the rectangular forms as shown on bait station 90 in FIG. 9 or the square forms as shown on a preferred embodiment bait station 100 as shown in FIG. 10.

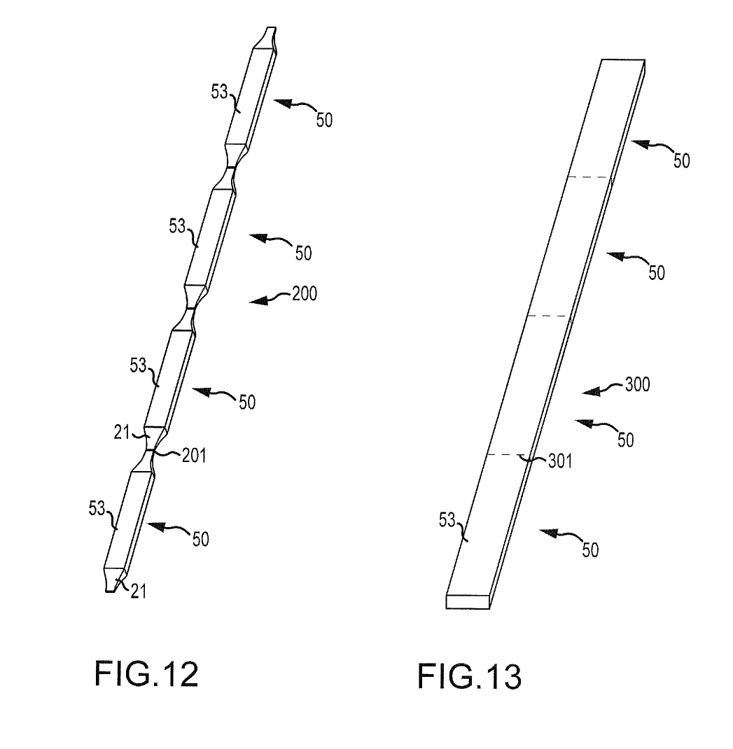

The bait stations of the present invention may be manufactured in the form of a continuous strip as shown in FIG. 12 and FIG. 13. The continuous form of the bait station strip lends itself to a number of manufacturing techniques for forming the base including, but not limited to, injection molding, stamping, vacuum forming and thermoforming. A representative section 200 of a continuous strip is shown in FIG. 12 wherein scored, or otherwise weakened, lines 201 between neighboring end tab segments 21, enable separation of bait stations either individually or in groups. While FIG. 12 illustrates a strip of bait stations with a discontinuous series of top covers 53, FIG. 13 shows a strip having a continuous top cover 53 wherein the scored, or otherwise weakened lines 301 permit not only separation of the bait station base, but also of the top cover 53.

Depending upon market need, bait stations may be separated into a variety of groups of units to be packaged for sale. Consumers have the option of separating the stations out to smaller segments, or using the longer strip depending upon the desired scope of insect control.

The bait station embodiments contemplated herein include those relating to a flexible insect bait station that allows mounting on irregular shaped surfaces or in places where conventional bait stations may not fit. The term flexible as used herein means the property of a material, to bend, without breaking, along at least one axis when a force is applied. The flexible property of the articles of the present invention provide for application on irregular surfaces, such as those having a radius, steps, corners, rough or broken features. The selection of material used to construct the bait station may dictate some aspects of the form due to varying characteristics of the materials when deformed. Likewise, the configuration of the bait holding chamber, or chambers, may be dictated by the desired amount of bait required to perform the insect control function of the bait station or by structural considerations relating to the amount of flex any particular container geometry may permit given the material used to form the base.

Types of materials useful in the construction of the bait stations according to the present invention include, but are not limited to, thermoplastic elastomers (TPE), rubber/polyolefin blends, silicone rubber, polystyrene, polyester, polyethylene, polypropylene, and for example, materials sold under the trade names of Dynaflex™, Versaflex™, and Kraton™.

Materials used to create the bait stations may be substantially colorless or transparent and thus be less noticeable or intrusive when placed in publicly visible areas. The nature of the TPEs and other polymers used in the present invention also permit the addition of dyes or colorants into the baits in order to adapt the articles to the intended use. Colors may be added in order to aid in camouflaging or highlighting the bait station depending on application. For example, wood like grains could be incorporated into the materials forming the bait stations to help them blend in, or become less intrusive to casual observation. Conversely, bright colors could be used to aid in locating spent or empty bait stations or to warn of the presence of insecticides.

As used herein, the term TPE refers to a class of compounds with both thermoplastic and elastomeric properties also known as thermoplastic rubbers. Such compounds include styrenic block copolymers, polyolefin blends, elastomeric alloys, thermoplastic polyurethanes, thermoplastic copolyesters, and thermoplastic polyamides.

Selection of the material used to form the base may be directed by the desired degree of flex for any given application and the cost of the materials involved. The use of materials, such as TPE, rubber/polyolefin blends, silicone rubber and the like, that permit stretching when deformed, may be useful in embodiments wherein flexing the base involves a degree of deformation in the peripheral side walls, such as in those shown in FIGS. 1, 2 and 3, in order to preserve the general geometry of the bait chamber.

A long single chamber structure, such as shown in FIG. 1 and FIG. 2, made of a more rigid material such as polystyrene may not provide sufficient resiliency to allow deformation of the wall structure. The use of less elastomeric, but still flexible, plastic materials such as polystyrene and polypropylene may suggest a bait station in the form an elongated strip comprising a base having a plurality of individual containers aligned in row, such as is shown in FIGS. 8, 9 and 10, wherein the base will still be able to flex between the individual containers. In cases where more rigid materials are used, the degree of flex in the overall strip may then be dictated by the number of individual containers in the strip per unit length of the base. The higher the density of containers per unit length, the more points of flex available in a give bait station.

The chamber for holding insect bait is defined by the container formed by the bottom wall and by the peripheral walls of the bait station base. The bait station may comprise a single long chamber or a plurality of smaller chambers depending upon the number of containers present in the strip.

The individual flexible insect bait stations of the present invention have a length of from about 5 cm to about 25 cm and a width of from about 0.5 cm to about 2.5 cm and a height of from about 0.25 cm to about 0.75 cm. Exemplary bait stations of the present invention have a length of from about 7.5 cm to about 15 cm, a width of about 1.0 cm to about 2.0 cm, and a height of about 0.3 cm to about 0.5 cm. The size of the openings, or apertures, in the top wall 52 as shown in FIG. 6, are dictated, in part, by the size of the target insect for the bait station, degree of insect access desired, level of containment required by the bait, and the size of the bait station itself. The size of the aperture or apertures may range from a hole of 0.25 cm in diameter, up to the size of the cavity itself, as shown in FIG. 1, defined by the peripheral side walls 12 of the base 11 of the bait station. Exemplary apertures include oval or rectangular openings of from about 0.25 cm to about 0.50 cm wide and from about 0.50 cm to about 2.0 cm long.

Exposure of bait to the atmosphere may initiate a drying of the bait, or volatilization of a bait active ingredient. In order to minimize negative environmental impact on bait prior to deployment, and to minimize loss of bait during transport, storage, and application, it may be desirable to equip the bait station with a removable top cover to seal the bait chamber. Examples of such top covers include rigid snap fit closures, rigid lids held on with a pressure-sensitive adhesive that permits removal of the lid from the base, and flexible lid structures that may be pulled back from base. Such flexible lid structures may be constructed from laminated foil, paper or plastic materials and attached via mechanical means such as crimping or via a pressure-sensitive adhesive. The top covers may be liquid and air tight in order to preserve the bait from environmental exposure and prevent leakage.

In order to provide a means for securing the bait station of the present invention to a wide array surfaces frequented by insects, an embodiment of the present invention includes a pressure-sensitive adhesive applied to the bottom surface of the bait station base. This adhesive layer permits the bait station to be positioned in an orientation that would otherwise not be possible without external fastening means. Having the adhesive already present on the bait station provides an integrated insect control system that increases the number of possible locations the bait station may be placed, and the ease at which it is secured. An adhesive backed bait station can be positioned at extreme angles, even inverted, or on surfaces subject to movement. The adhesive layer is preferably covered by a removable protective layer to allow transport, storage and easy handling of the bait station prior to application. The protective layer may then be peeled away when the consumer desires to secure the bait station on the target surface.

The bait station of the present invention preferably includes a base disposed between two end-tab segments. The end-tab segments may provide a means for grasping and handling the bait station before and after use. The size and shape of the end-tabs useful in the present may be influenced a number of factors including size of the bait station, manufacturing requirements such as mold capabilities and other processing considerations, and design considerations for providing access pathways for target insects. For example, it may be desirable to have a very basic flat tab structure 21 as shown in FIG. 9. The geometry of such a flat tab may be nothing more than a featureless segment the same width as the base, may include an enlarged area to facilitate grasping, or it may include a taper or scalloped portion to minimize the weakened area 201 shown in FIG. 12. The end tab may also serve as a ramp or ladder structure for insects climbing upon the bait station. As an access pathway, such a tab may be in the form of a ramp or a series of incremental steps from the mounting surface up to the height of the bait station.

The insect bait stations of the present invention may include bait suitable for attracting insects. Baits useful in the present invention include solid, paste and gels, and even liquid forms in certain applications. The baits typically contain one or more insecticides that are either ingested or externally contacted by the target insect. Suitable bait compositions are well known in the art, including baits such as those found in U.S. Pat. Nos. 4,386,071, 4,834,977, 4,845,103, 5,021,237, 5,547,955, and 5,676,961 incorporated herein by reference.

Methods of Manufacture

The bait stations of the present invention may be manufactured by any method well known in the art for forming small plastic or thermoplastic articles. Techniques such as injection molding, stamping, vacuum forming, thermoforming are examples of acceptable means of manufacture.

The bait stations may be formed individually, in groups of multiple attached units or continuously in a coplanar array of long strips containing a plurality of contiguous units as shown in FIG. 12 and FIG. 13. The covers may be applied discontinuously as shown by covers 53 in FIG. 12, or as a continuous strip 53 as shown in FIG. 13. When produced in multiple unit configurations, the bait station strips include scored or weakened sections 201 as shown in FIGS. 12, and 301 as shown in FIG. 13 intermediate of each of said bait stations providing for separation of one station from another. This weakened area provides a means for users to separate individual or groups of units prior to use and also provides a means to separate subsections prior to packaging for sale.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. An insect bait station in the form of an elongated strip comprising at least one container defining a chamber for holding insect bait, the container comprising a base having a bottom wall, and peripheral side walls wherein the base is constructed of a flexible material providing for mounting the bait station on irregular surfaces.

2. The bait station of claim 1 wherein the strip has a length of from about 5 cm to about 25 cm and a width of from about 0.5 cm to about 2.5 cm.

3. The bait station of claim 2 wherein the base has a bottom surface to which a peel-off adhesive strip is attached.

4. The bait station according to claim 2, wherein the base is provided with a top wall having one or more openings for allowing the entry and exit of insects into and from said chamber.

5. The bait station of claim 3, wherein the base includes a removable top cover providing a closure for the chamber.

6. The bait station of claim 5 wherein said base is disposed between two end-tab segments.

7. The bait station of claim 1 further comprising an insect bait in the chamber wherein the bait is selected from the group consisting of liquid, gel, paste and solid baits.

8. The bait station of claim 1, wherein the base is constructed of one or more materials selected from the group consisting of thermoplastic elastomers, rubber/polyolefin blends, silicone rubber, polystyrene, polyester, polyethylene, or polypropylene.

9. An insect bait station in the form of an elongated strip comprising a base having a plurality of containers aligned in row, each of the containers having a bottom wall and peripheral side walls defining a chamber for holding insect bait, wherein at least the bottom wall is constructed of a flexible material providing for mounting the bait station on irregular surfaces.

10. The bait station of claim 9 wherein the strip has a length of from about 5 cm to about 25 cm and a width of from about 0.5 cm to about 2.5 cm.

11. The bait station of claim 10, wherein the base has a bottom surface to which a peel-off adhesive strip is attached.

12. The bait station according to claim 11, wherein the containers are provided with a top wall having one or more openings for allowing the entry and exit of insects into and from said chambers.

13. The bait station of claim 10, wherein the base includes a removable top cover providing a closure for the chambers.

14. The bait station of claim 13 wherein said base is disposed between two end-tab segments.

15. The bait station of claim 14 further comprising an insect bait in each chamber wherein the bait is selected from the group consisting of liquid, gel, paste and solid baits.

16. The bait station of claim 9, wherein the base is constructed of one or more materials selected from the group consisting of thermoplastic elastomers, rubber/polyolefin blends, silicone rubber, polystyrene, polyester, polyethylene, or polypropylene.

17. A method of manufacturing insect bait stations, the method comprising the production of insect bait stations in the form of an elongated strip comprising at least one container defining a chamber for holding insect bait, the container comprising a base having a bottom wall, and peripheral side walls wherein the base is constructed of a flexible material providing for mounting the bait station on irregular surfaces, wherein the bait stations are produced in strips of a plurality of said bait stations in a coplanar array, said strips having a weakened section intermediate of each of said bait stations providing for separation of one station from another.
